(19) United States
(12) Patent Application Publication
(10) Pub. No.: US 2024/0412911 A1
(43) Pub. Date: Dec. 12, 2024

(54) ELECTRONIC COMPONENT AND MANUFACTURING METHOD THEREOF

(71) Applicant: Murata Manufacturing Co., Ltd., Kyoto-fu (JP)

(72) Inventors: Daisuke OTSUKA, Nagaokakyo-shi (JP); Yoshifumi MAKI, Nagaokakyo-shi (JP)

(73) Assignee: Murata Manufacturing Co., Ltd., Kyoto-fu (JP)

(21) Appl. No.: 18/813,830

(22) Filed: Aug. 23, 2024

Related U.S. Application Data
(63) Continuation of application No. PCT/JP2022/047650, filed on Dec. 23, 2022.

(30) Foreign Application Priority Data
Mar. 28, 2022 (JP) 2022-051698

(51) Int. Cl. H01F 17/00; H01F 41/04

(52) U.S. Cl. CPC H01F 17/0013; H01F 41/041

(57) ABSTRACT

An electronic component includes a base body having first and second planes, and a ridge portion connecting the first and second planes; and a conductive member continuously on at least a part of the first plane and at least a part of the ridge portion. The first plane has a first contact surface that is in contact with the conductive member, and the ridge portion has a second contact surface that is in contact with the conductive member and in a cross section orthogonal to each of the first plane and the second plane and intersecting the conductive member, the first contact surface, and the second contact surface.

### CROSS-REFERENCE TO RELATED APPLICATIONS

This application claims benefit of priority to International Patent Application No. PCT/JP2022/047650, filed Dec. 23, 2022, and to Japanese Patent Application No. 2022-051698, filed Mar. 28, 2022, the entire contents of each are incorporated herein by reference.

### BACKGROUND

### Technical Field

The present disclosure relates to an electronic component and a manufacturing method thereof.

### Background Art

In the related art, an electronic component is disclosed in Japanese Unexamined Patent Application Publication No. 2006-114626. This electronic component includes a rectangular parallelepiped base body and a conductive member provided on an outer surface of the base body. The base body has a bottom surface and a top surface that face each other, and a first end surface and a second end surface that connect the bottom surface and the top surface and face each other. The conductive member is provided continuously over the bottom surface and the first end surface. The conductive member includes a first portion located on the first end surface side and a second portion located on the bottom surface side. An end portion of the first portion on the top surface side has a thickness that decreases from the bottom surface side toward the top surface side. An end portion of the second portion on the second end surface side has a thickness that decreases from the first end surface side toward the second end surface side.

### SUMMARY

However, in the electronic component in the related art, both the end portion of the first portion of the conductive member on the top surface side and the end portion of the second portion of the conductive member on the second end surface side have a thickness that decreases from the bottom surface side toward the top surface side or from the first end surface side toward the second end surface side. In a case where the thickness is thin, there is a problem in that, for example, gases such as water vapor enter from both end portions of the conductive member, and the conductive member is damaged.

In view of the above, the present disclosure provides an electronic component capable of suppressing the entry of gases and a manufacturing method thereof.

Accordingly, one aspect of the present disclosure provides an electronic component including a base body having a first plane, a second plane, and a ridge portion connecting the first plane and the second plane; and a conductive member provided continuously on at least a part of the first plane and at least a part of the ridge portion. The first plane has a first contact surface that is in contact with the conductive member. The ridge portion has a second contact surface that is in contact with the conductive member. In a cross section orthogonal to each of the first plane and the second plane and intersecting the conductive member, the first contact surface, and the second contact surface, when a thickness of the conductive member in a direction orthogonal to the first plane at a center portion of the first contact surface in the cross section is defined as a first thickness, and a thickness of the conductive member in the direction orthogonal to the first plane at an end portion of the first contact surface on a side opposite to the ridge portion with respect to the center portion of the first contact surface in the cross section is defined as a second thickness, the first thickness is equal to or less than 1.3 times the second thickness, and the second thickness is equal to or less than 1.3 times the first thickness.

According to the aspect, since the first thickness and the second thickness are approximately the same, the thickness of the end portion on the side opposite to the ridge portion side can be made thicker than that in the related art in a portion of the conductive member provided on at least a part of the first plane. Therefore, for example, it is possible to suppress gases such as water vapor entering through the end portion.

Preferably, in the electronic component according to the embodiment, the first plane is a mounting surface. Also, in the cross section, when a thickness of the conductive member in a direction that passes through a center portion of the second contact surface in the cross section and is orthogonal to a plane in contact with the center portion of the second contact surface is defined as a third thickness, the first thickness is equal to or less than 1.3 times the third thickness, the second thickness is equal to or less than 1.3 times the third thickness, and the third thickness is equal to or less than 1.3 times each of the first thickness and the second thickness.

According to the above embodiment, since the first to third thicknesses are approximately the same, and the overall thickness of the conductive member is uniform, when the first plane faces a circuit board or the like and the electronic component is mounted on the circuit board or the like, the posture of the electronic component can be stabilized. In addition, since the overall thickness of the conductive member is uniform, the thickness of the end portion of the conductive member present on the ridge portion side can also be made thicker than that in the related art. Therefore, for example, the entry of gases such as water vapor can be further suppressed.

Preferably, in the electronic component according to the embodiment, the first thickness is equal to or less than 1.2 times each of the second thickness and the third thickness, the second thickness is equal to or less than 1.2 times each of the first thickness and the third thickness, and the third thickness is equal to or less than 1.2 times each of the first thickness and the second thickness.

According to the above embodiment, when the electronic component is mounted on a circuit board or the like, the posture of the electronic component can be more stabilized. In addition, for example, the entry of gases such as water vapor can be further suppressed.

Preferably, in the electronic component according to the embodiment, in the cross section, the end portion of the first contact surface is located closer to the center portion side of the first contact surface than an outermost end of the conductive member on the side opposite to the ridge portion with respect to the center portion of the first contact surface.

When the electronic component is mounted, the molten solder spreads out and may thus wrap around the outermost end of the conductive member. According to the above embodiment, it is possible to suppress excessive spreading-out of the molten solder in a region of the first plane of the base body where the conductive member is not provided.

Preferably, in the electronic component according to the embodiment, the conductive member is provided continuously on at least a part of the first plane, at least a part of the ridge portion, and at least a part of the second plane, and the second plane has a third contact surface that is in contact with the conductive member. Also, in the cross section, an end portion of the third contact surface on a side opposite to the ridge portion with respect to a center portion of the third contact surface is located closer to a center portion side of the third contact surface than an outermost end of the conductive member on the side opposite to the ridge portion with respect to the center portion of the third contact surface.

When the electronic component is mounted, the molten solder spreads out and may thus wrap around the outermost end of the conductive member. According to the above embodiment, it is possible to suppress excessive spreading-out of the molten solder in a region of the second plane of the base body where the conductive member is not provided.

Preferably, in the electronic component according to the embodiment, the conductive member is provided continuously on at least a part of the first plane, at least a part of the ridge portion, and at least a part of the second plane, and the second plane has a third contact surface that is in contact with the conductive member. Also, in the cross section, when a thickness of the conductive member in a direction orthogonal to the second plane at a center portion of the third contact surface is defined as a fourth thickness, the first thickness is thicker than the fourth thickness.

In a case where the first plane side of the base body is a mounting surface side of the electronic component, when the electronic component is mounted, the molten solder is pushed aside by a part of the conductive member provided on at least a part of the first plane and wraps around to the second plane side of the base body. The solder that wraps around forms a fillet. According to the above embodiment, since the thickness of the conductive member provided on at least a part of the first plane is relatively thick, the amount of the solder pushed aside is increased, and the height of the fillet formed on the second plane side can be increased. As a result, the electronic component can be more firmly fixed to the circuit board or the like.

Preferably, in the electronic component according to the embodiment, the conductive member is provided continuously on at least a part of the first plane, at least a part of the ridge portion, and at least a part of the second plane, and the second plane has a third contact surface that is in contact with the conductive member. Also, in the cross section, when a thickness of the conductive member in a direction orthogonal to the second plane at a center portion of the third contact surface is defined as a fourth thickness, a thickness of the conductive member in the direction orthogonal to the second plane at an end portion of the third contact surface located on the ridge portion side is defined as a fifth thickness, and a thickness of the conductive member in the direction orthogonal to the second plane at an end portion of the third contact surface located on a side opposite to the ridge portion with respect to the center portion of the third contact surface is defined as a sixth thickness, each of the fifth thickness and the sixth thickness is thicker than the fourth thickness.

According to the above embodiment, a contact area between the fillet formed during mounting and the conductive member can be increased compared with a case where the thickness of a part of the conductive member provided on at least a part of the second plane of the base body is uniform along the second plane. Therefore, the electronic component can be more firmly fixed to the circuit board or the like.

Preferably, in the electronic component according to the embodiment, the conductive member is provided continuously on at least a part of the first plane, at least a part of the ridge portion, and at least a part of the second plane, and the second plane has a third contact surface that is in contact with the conductive member. Also, in the cross section, when a thickness of the conductive member in a direction orthogonal to the second plane at an end portion of the third contact surface located on the ridge portion side is defined as a fifth thickness, and a thickness of the conductive member in the direction orthogonal to the second plane at an end portion of the third contact surface located on a side opposite to the ridge portion with respect to a center portion of the third contact surface is defined as a sixth thickness, the fifth thickness is thicker than the sixth thickness.

According to the above embodiment, the area of the conductive member that can come into contact with the solder is increased compared with a case where the thickness of a part of the conductive member provided on at least a part of the second plane of the base body is uniform along the second plane. Therefore, the electronic component can be more firmly fixed to the circuit board or the like.

Preferably, in the electronic component according to the embodiment, the conductive member is provided continuously on at least a part of the first plane, at least a part of the ridge portion, and at least a part of the second plane, and the conductive member includes a plurality of conductive members, and the plurality of conductive members are provided on at least a part of the second plane and electrically independent of each other. When viewed in a direction orthogonal to the second plane, the plurality of conductive members extend in a first direction that is parallel to the second plane and is from the ridge portion toward a center of the second plane, and are arranged side by side in a direction that is orthogonal to the first direction and is parallel to the second plane, and in each of the plurality of conductive members, a width of a center in an extension direction is smaller than each of widths of both end portions of the extension direction.

According to the above embodiment, even in a case where a plurality of conductive members are provided on at least a part of the second plane, the width of each of the plurality of conductive members at the center in the extension direction is smaller than the widths at the both end portions in the extension direction. Therefore, it is possible to suppress the short-circuiting between the conductive members adjacent to each other by the solder which spreads out on the base body during mounting of the electronic component.

Preferably, in the electronic component according to the embodiment, a coil that is provided in the base body and is electrically connected to the conductive member is further included.

According to the above embodiment, it is possible to obtain a coil component having a conductive member capable of suppressing the local flow of the current.

Preferably, in the electronic component according to the embodiment, the conductive member is provided continuously only with at least a part of the first plane, at least a part of the ridge portion, and at least a part of the second plane.

According to the above embodiment, the area of the region in the base body where the conductive member is provided can be reduced, thereby suppressing the parasitic capacitance that can be generated between the coil and the conductive member. Accordingly, the high frequency characteristics of the coil component can be improved.

Preferably, in one embodiment of a manufacturing method of an electronic component, the manufacturing method includes a step of preparing a base body having a first plane, a second plane, and a ridge portion connecting the first plane and the second plane; and a step of forming a conductive member, the conductive member being formed continuously on at least a part of the first plane and at least a part of the ridge portion such that the first plane has a first contact surface that is in contact with the conductive member and the ridge portion has a second contact surface that is in contact with the conductive member. The step of forming the conductive member includes a step of applying a photosensitive conductive paste to at least a part of the first plane and at least a part of the ridge portion. Also, the step of forming the conductive member includes a step of exposing the photosensitive conductive paste such that, in a cross section orthogonal to each of the first plane and the second plane and intersecting the conductive member, the first contact surface, and the second contact surface, when a thickness of the conductive member in a direction orthogonal to the first plane at a center portion of the first contact surface in the cross section is defined as a first thickness, and a thickness of the conductive member in the direction orthogonal to the first plane at an end portion of the first contact surface on a side opposite to the ridge portion with respect to the center portion of the first contact surface in the cross section is defined as a second thickness, the first thickness is equal to or less than 1.3 times the second thickness, and the second thickness is equal to or less than 1.3 times the first thickness. In addition, the step of forming the conductive member includes a step of developing the photosensitive conductive paste.

According to the above embodiment, for example, the entry of gases such as water vapor can be suppressed.

Preferably, in the manufacturing method of an electronic component according to the embodiment, in the step of exposing, the photosensitive conductive paste is further exposed such that, when a thickness of the conductive member in a direction that passes through a center portion of the second contact surface in the cross section and is orthogonal to a plane in contact with the center portion of the second contact surface is defined as a third thickness, the first thickness is equal to or less than 1.3 times the third thickness, the second thickness is equal to or less than 1.3 times the third thickness, and the third thickness is equal to or less than 1.3 times each of the first thickness and the second thickness.

According to the above embodiment, it is possible to manufacture an electronic component that can stabilize a posture when mounted. In addition, for example, the entry of gases such as water vapor can be further suppressed.

Preferably, in the manufacturing method of an electronic component according to the embodiment, in the step of exposing, the photosensitive conductive paste is exposed by irradiating the photosensitive conductive paste with a laser beam.

According to the above embodiment, the shape of the conductive member can be controlled with high accuracy.

Preferably, in the manufacturing method of an electronic component according to the embodiment, the laser beam is applied such that a temperature of the base body becomes equal to or lower than a firing temperature of the base body.

According to the above embodiment, the damage to the base body caused by the laser irradiation can be suppressed.

According to one aspect of the present disclosure, it is possible to realize an electronic component capable of suppressing the entry of gases.

### BRIEF DESCRIPTION OF THE DRAWINGS

FIG. 1 is a perspective view illustrating a first embodiment of an electronic component;

FIG. 2 is a cross-sectional view taken along line X-X of FIG. 1;

FIG. 3 is an exploded plan view of the electronic component;

FIG. 4 is an enlarged view of part A in FIG. 2;

FIG. 5 is a cross-sectional view illustrating a second embodiment of the electronic component;

FIG. 6 is a cross-sectional view illustrating a third embodiment of the electronic component;

FIG. 7 is a cross-sectional view illustrating a fourth embodiment of the electronic component;

FIG. 8 is a perspective view illustrating a fifth embodiment of the electronic component;

FIG. 9 is a cross-sectional view illustrating a sixth embodiment of the electronic component; AND

FIG. 10 is an enlarged view of part A in FIG. 9.

### DETAILED DESCRIPTION

An electronic component according to an aspect of the present disclosure will be described below in detail with reference to the illustrated embodiment. Note that the drawings include some schematic views and do not reflect actual dimensions or proportions in some cases.

### First Embodiment

### (Overall Configuration)

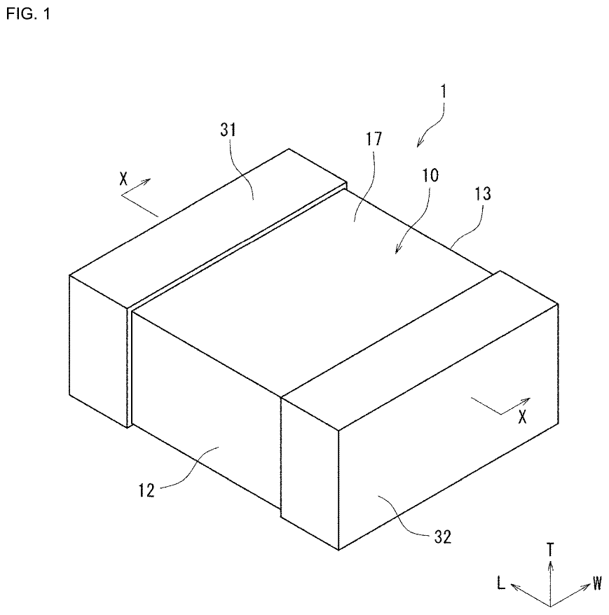

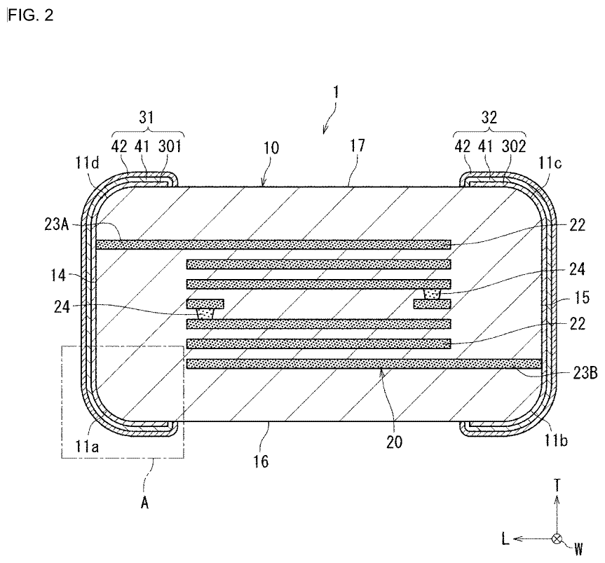

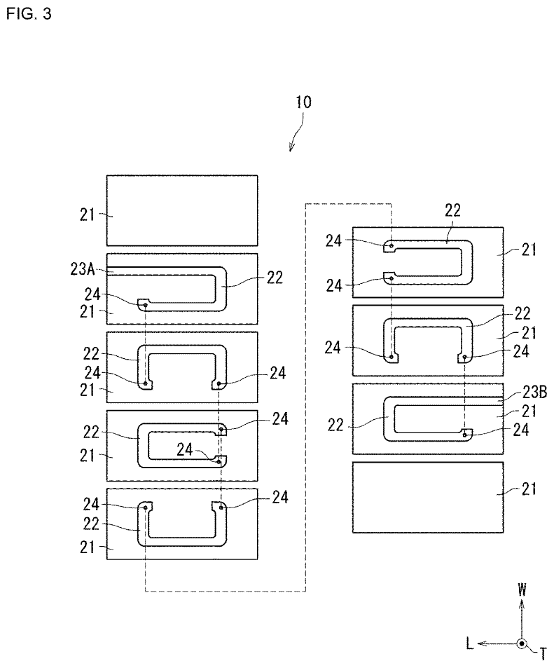

FIG. 1 is a perspective view illustrating a first embodiment of an electronic component. FIG. 2 is a cross-sectional view taken along line X-X (LT cross-sectional view) of FIG. 1. FIG. 3 is an exploded plan view of the electronic component.

The electronic component is not particularly limited as long as it has a configuration in which an outer electrode is provided on an outer surface of a base body. In this embodiment, the electronic component is a coil component.

An L direction is a length direction of an electronic component 1, a W direction is a width direction of the electronic component 1, and a T direction is a height direction of the electronic component 1. In this embodiment, the L direction is orthogonal to the W direction. The T direction is orthogonal to both the L direction and the W direction. Hereinafter, a forward direction of the T direction will be referred to as an upper side, and a reverse direction of the T direction will be referred to as a lower side. In addition, an LT plane refers to a plane parallel to the L direction and the T direction. A WL plane refers to a plane parallel to the W direction and the L direction. A TW plane refers to a plane parallel to the T direction and the W direction.

As illustrated in FIGS. 1 to 3, the electronic component 1 includes a base body 10, a coil 20 provided inside the base body 10, and a first outer electrode 31 and a second outer electrode 32 provided on an outer surface of the base body 10 and electrically connected to the coil 20.

The electronic component 1 is electrically connected to wiring of a circuit board (not illustrated) with the first and second outer electrodes 31 and 32 interposed therebetween. The electronic component 1 is used, for example, as a noise removal filter and is used in electronic devices such as personal computers, DVD players, digital cameras, TVs, mobile phones, and car electronics.

The base body 10 is preferably a sintered body of a plurality of magnetic layers 21. The magnetic layer 21 is stacked in the T direction. The magnetic layer 21 is made of a magnetic material. The magnetic material is not particularly limited, but for example, a Ni—Cu—Zn based ferrite material containing Fe₂O₃, ZnO, CuO, and NiO can be used. A thickness of the magnetic layer 21 is, for example, 5 μm or more and 30 μm or less (i.e., from 5 μm to 30 μm). The base body 10 may partially include a nonmagnetic layer.

A shape of the base body 10 is not particularly limited, but is formed in a substantially rectangular parallelepiped shape in this embodiment. The outer surface of the base body 10 has a first end surface 14 and a second end surface 15 facing each other in the L direction, a first side surface 12 and a second side surface 13 facing each other in the W direction, and a bottom surface 16 and a top surface 17 facing each other in the T direction. The top surface 17 is disposed on an upper side of the bottom surface 16. In the present specification, a direction from the second end surface 15 to the first end surface 14 in the L direction will be referred to as a “forward L direction”, an opposite direction of the forward L direction will be referred to as a “reverse L direction”, a direction from the first side surface 12 to the second side surface 13 in the W direction will be referred to as a “forward W direction”, an opposite direction of the forward W direction will be referred to as a “reverse W direction”, a direction from the bottom surface 16 to the top surface 17 in the T direction will be referred to as a “forward T direction”, and an opposite direction of the forward T direction will be referred to as a “reverse T direction”.

The outer surface of the base body 10 includes a first ridge portion 11a connecting the first end surface 14 and the bottom surface 16, a second ridge portion 11b connecting the second end surface 15 and the bottom surface 16, a third ridge portion 11c connecting the second end surface 15 and the top surface 17, a fourth ridge portion 11d connecting the first end surface 14 and the top surface 17, a fifth ridge portion (not illustrated) connecting the first side surface 12 and the bottom surface 16, a sixth ridge portion (not illustrated) connecting the second side surface 13 and the bottom surface 16, a seventh ridge portion (not illustrated) connecting the second side surface 13 and the top surface 17, an eighth ridge portion (not illustrated) connecting the first side surface 12 and the top surface 17, a ninth ridge portion (not illustrated) connecting the first end surface 14 and the first side surface 12, a tenth ridge portion (not illustrated) connecting the second end surface 15 and the first side surface 12, an eleventh ridge portion (not illustrated) connecting the second end surface 15 and the second side surface 13, and a twelfth ridge portion (not illustrated) connecting the first end surface 14 and the second side surface 13.

The first to twelfth ridge portions are convex curved surfaces on the outer side portion of the base body 10. The shapes of the first to twelfth ridge portions are not particularly limited as long as they are convex curved surfaces on the outer side portion of the base body 10. In this embodiment, in the cross section illustrated in FIG. 2, each shape of the first to fourth ridge portions 11a to 11d is an arc shape. The radius of curvature of the arc is not particularly limited. The same applies to the fifth to twelfth ridge portions. In a case where the electronic component 1 is minute, the first to twelfth ridge portions can be observed using an optical microscope, for example, at a magnification of 50 times to 500 times.

In this embodiment, any surface of the first end surface 14, the second end surface 15, the first side surface 12, the second side surface 13, the bottom surface 16, and the top surface 17 corresponds to a “first plane” recited in the claims. Any ridge portion of the first to twelfth ridge portions connected to the “first plane” corresponds to a “ridge portion” recited in the claims. Any surface of the first end surface 14, the second end surface 15, the first side surface 12, the second side surface 13, the bottom surface 16, and the top surface 17, other than the “first plane”, which is connected to the “ridge portion”, corresponds to a “second plane” recited in the claims. In this embodiment, all the surfaces of the first end surface 14, the second end surface 15, the first side surface 12, the second side surface 13, the bottom surface 16, and the top surface 17 are planar surfaces, but in a case where each of these surfaces has, for example, a step or the like, the term “first plane” refers to a plane that is continuously connected to the ridge portion. The same applies to the “second plane”. In addition, in this embodiment, the shape of the base body 10 is a rectangular parallelepiped shape, but the present disclosure is not limited to this, and an angle formed by two surfaces intersecting with each other among the first end surface 14, the second end surface 15, the first side surface 12, the second side surface 13, the bottom surface 16, and the top surface 17 need not be a right angle.

Hereinafter, in order to simplify the description, the bottom surface 16 will be referred to as the “first plane”, the first end surface 14 and the second end surface 15 will be referred to as the “second plane”, and the first ridge portion 11a and the second ridge portion 11b will be referred to as the “ridge portion”. In this case, the LT cross section is “a cross section orthogonal to each of the first plane and the second plane and intersecting the conductive member, the first contact surface, and the second contact surface” recited in the claims.

The coil 20 includes a plurality of coil wires 22 stacked in the T direction, a plurality of via conductors 24 that extend in the T direction and connect the coil wires 22 adjacent to each other in the T direction, a first extended conductor 23A connected to the uppermost coil wire 22, and a second extended conductor 23B connected to the lowermost coil wire 22.

Each coil wire 22 is provided in each of the plurality of magnetic layers 21 excluding the uppermost magnetic layer 21 and the lowermost magnetic layer 21. Each coil wire 22 is wound along a plane parallel to the WL plane, is arranged side by side in the T direction, and is electrically connected in series to form a spiral. Each coil wire 22 is wound with less than one turn. The via conductor 24 passes through the magnetic layer 21 in the T direction. The coil wires 22 adjacent to each other in the T direction are electrically connected in series with the via conductors 24 interposed therebetween. Each of the uppermost magnetic layer 21 and the lowermost magnetic layer 21 may be configured by a plurality of layers.

The first extended conductor 23A extends linearly from an end portion on a side opposite to the end portion to which the via conductor 24 is connected in the uppermost coil wire 22 to the first end surface 14 of the base body 10. The first extended conductor 23A is exposed from the first end surface 14 and is connected to the first outer electrode 31. The second extended conductor 23B extends linearly from an end portion on a side opposite to the end portion to which the via conductor 24 is connected in the lowermost coil wire 22 to the second end surface 15 of the base body 10. The second extended conductor 23B is exposed from the second end surface 15 and is connected to the second outer electrode 32.

The coil wire 22 and the first and second extended conductors 23A and 23B are formed of, for example, a conductive material such as Ag or Cu. The number of the coil wires 22 stacked is not particularly limited. By firing the base body 10, a coil 20 that forms a spiral in the T direction is obtained.

The first outer electrode 31 includes a first conductive member 301 provided on an outer surface of the base body 10, a first plating layer 41 that covers an outer surface of the first conductive member 301, and a second plating layer 42 that covers an outer surface of the first plating layer 41. The second outer electrode 32 includes a second conductive member 302 provided on the outer surface of the base body 10, a first plating layer 41 that covers the outer surface of the second conductive member 302, and a second plating layer 42 that covers the outer surface of the first plating layer 41.

The first plating layer 41 and the second plating layer 42 protect the first conductive member 301 and the second conductive member 302 from the external environment. The metal contained in the first plating layer 41 is not particularly limited, and is, for example, nickel. The metal contained in the second plating layer 42 is not particularly limited, and is, for example, tin. The thickness of each of the first plating layer 41 and the second plating layer 42 is not particularly limited, and is 2 μm or more and 15 μm or less (i.e., from 2 μm to 15 μm), for example. In this embodiment, the number of layers of the plating layer is two, but the present disclosure is not limited thereto, and the number of layers may be one or three or more. The first plating layer 41 and the second plating layer 42 may be provided as necessary, and need not be provided.

The first conductive member 301 is provided continuously on at least a part of the bottom surface 16 (first plane) and at least a part of the first ridge portion 11a. In this embodiment, the first conductive member 301 is provided continuously on the entire surfaces of the first end surface 14, the first ridge portion 11a, the fourth ridge portion 11d, the ninth ridge portion, and the twelfth ridge portion, and the end portions of the bottom surface 16, the top surface 17, the first side surface 12, and the second side surface 13 on the first end surface 14 side. The first conductive member 301 is connected to the first extended conductor 23A and is electrically connected to the coil 20. The first conductive member 301 is made of, for example, a low-resistance metal material such as Ag. For example, the first conductive member 301 is obtained by firing a photosensitive conductive paste containing conductive particles such as Ag powder and a resin composition containing a photosensitive resin.

The position of the first conductive member 301 with respect to the outer surface of the base body 10 is not particularly limited as long as the first conductive member 301 is provided continuously on at least a part of the bottom surface 16 (first plane) and at least a part of the first ridge portion 11a. For example, the first conductive member 301 may be provided continuously only with a part of the bottom surface 16 on the forward L direction side and a part of the first ridge portion 11a. In addition, for example, the first conductive member 301 may have an L-shape that is formed over the end portion of the bottom surface 16 on the forward L direction side, the entire surface of the first ridge portion 11a, and the end portion of the first end surface 14 on the reverse T direction side. In addition, for example, the first conductive member 301 may include a plurality of portions provided in a dot shape on one or more surfaces of the first side surface 12, the second side surface 13, the first end surface 14, the second end surface 15, the bottom surface 16, and the top surface 17.

The second conductive member 302 is provided continuously on at least a part of the bottom surface 16 (first plane) and at least a part of the second ridge portion 11b. In this embodiment, the second conductive member 302 is provided continuously on the entire surfaces of the second end surface 15, the second ridge portion 11b, the third ridge portion 11c, the tenth ridge portion, and the eleventh ridge portion, and the end portions of the bottom surface 16, the top surface 17, the first side surface 12, and the second side surface 13 on the second end surface 15 side. The second conductive member 302 is connected to the second extended conductor 23B of the coil 20 and is electrically connected to the coil 20. The second conductive member 302 is made of, for example, a low-resistance metal material such as Ag. The second conductive member 302 is obtained, for example, by firing a photosensitive conductive paste containing conductive particles such as Ag powder and a resin composition containing a photosensitive resin.

The position of the second conductive member 302 with respect to the outer surface of the base body 10 is not particularly limited as long as the second conductive member 302 is provided continuously on at least a part of the first plane (bottom surface 16) and at least a part of the second ridge portion 11b. For example, the second conductive member 302 may be provided continuously only with a part of the bottom surface 16 on the reverse L direction side and a part of the second ridge portion 11b. In addition, for example, the second conductive member 302 may have an L-shape that is formed over the end portion of the bottom surface 16 on the reverse L direction side, the entire surface of the second ridge portion 11b, and the end portion of the second end surface 15 on the reverse T direction side. In addition, for example, the second conductive member 302 may include a plurality of portions provided in a dot shape on one or more surfaces of the first side surface 12, the second side surface 13, the first end surface 14, the second end surface 15, the bottom surface 16, and the top surface 17.

### (Thickness of Conductive Member)

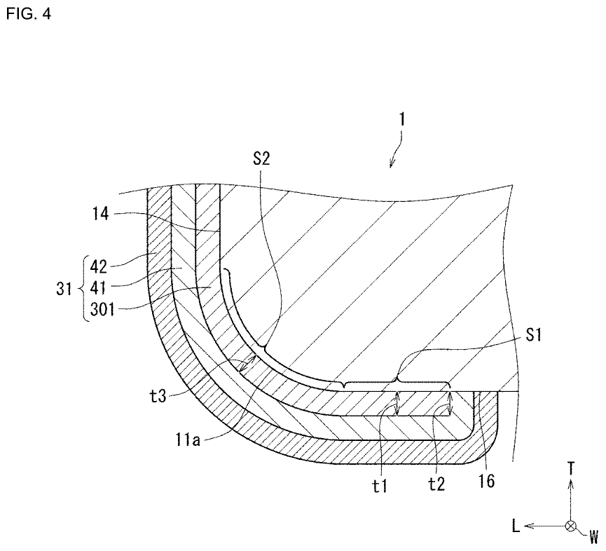

Next, the thickness of the conductive member will be described in detail. FIG. 4 is an enlarged view of part A in FIG. 2. In the following, the thickness of the first conductive member 301 will be described, but the same applies to the thickness of the second conductive member 302. Therefore, detailed description of the second conductive member 302 will be omitted.

As illustrated in FIG. 4, the bottom surface 16 (first plane) has a first contact surface S1 that is in contact with the first conductive member 301. The first ridge portion 11a has a second contact surface S2 that is in contact with the first conductive member 301.

The thickness of a portion of the first conductive member 301 provided on the bottom surface 16 is uniform. In other words, the thickness of the portion of the first conductive member 301 provided on the bottom surface 16 is substantially the same. Specifically, in FIG. 4, when the thickness of the first conductive member 301 in a direction that passes through the center portion of the first contact surface S1 and is orthogonal to the first contact surface S1 is defined as a first thickness t1, and the thickness of the first conductive member 301 in a direction that passes through the end portion of the first contact surface S1 on the side opposite to the first ridge portion 11a with respect to the center portion of the first contact surface S1 and is orthogonal to the first contact surface S1 is defined as a second thickness t2, the first thickness t1 is equal to or less than 1.3 times the second thickness t2, and the second thickness t2 is equal to or less than 1.3 times the first thickness t1.

The above description also applies to the case where the first plane is a plane other than the bottom surface 16. For example, in a case where the first plane is the first side surface 12 and the second plane is the top surface 17, the first side surface 12 has a first contact surface that is in contact with the first conductive member 301, and the eighth ridge portion that connects the first side surface 12 and the top surface 17 has a second contact surface that is in contact with the first conductive member 301. In a TW cross section orthogonal to the first side surface 12 and the top surface 17 and intersecting the first conductive member 301, the first contact surface, and the second contact surface, when the thickness of the first conductive member 301 at the center portion of the first contact surface is defined as a first thickness, and the thickness of the first conductive member 301 at the end portion of the first contact surface on the side opposite to the eighth ridge portion with respect to the center portion of the first contact surface is defined as a second thickness, the first thickness is equal to or less than 1.3 times the second thickness, and the second thickness is equal to or less than 1.3 times the first thickness.

With the electronic component 1, since the first thickness t1 and the second thickness t2 are approximately the same, the thickness of the end portion on the side opposite to the first ridge portion 11a side can be made thicker than that in the related art in a portion of the first conductive member 301 provided on a part of the bottom surface 16. Therefore, for example, it is possible to suppress gases such as water vapor entering through the above-described end portion on the side opposite to the first ridge portion 11a side. As a result, for example, it is possible to suppress damage to the first conductive member 301, the coil 20, and the like caused by the gas. In a case where the thickness of the end portion is thin, there is a likelihood that the gas is transmitted through the end portion, the gas enters through a gap between the end portion and the base body, or the like. The damage caused by the gas includes electrochemical migration that may occur in the first conductive member 301 and the extended conductors 23A and 23B and the coil wire 22 of the coil 20 in a case where the gas is, for example, water vapor. In a case where the electrochemical migration has proceeded, there is a likelihood that a short circuit may occur between adjacent wires. In a case where the gas is, for example, hydrogen sulfide, the damage caused by the gas includes corrosion that may occur in the first conductive member 301 and the extended conductors 23A and 23B and the coil wire 22 of the coil 20.

Preferably, the bottom surface 16 is a mounting surface, and as illustrated in FIG. 4, when the thickness of the first conductive member 301 in a direction that passes through the center portion of the second contact surface S2 and is orthogonal to a plane that is in contact with the center portion of the second contact surface S2 is defined as a third thickness t3, the first thickness t1 is equal to or less than 1.3 times the third thickness t3, the second thickness t2 is equal to or less than 1.3 times the third thickness t3, and the third thickness t3 is equal to or less than 1.3 times each of the first thickness t1 and the second thickness t2.

With the above-described configuration, since the first to third thicknesses t1 to t3 are approximately the same, and the overall thickness of the bottom surface 16 of the first conductive member 301 and the portion provided on the first ridge portion 11a is uniform, when the bottom surface 16 faces the circuit board or the like and the electronic component 1 is mounted on the circuit board or the like, the posture of the electronic component 1 can be stabilized.

Preferably, the first thickness t1 is equal to or less than 1.2 times each of the second thickness t2 and the third thickness t3, the second thickness t2 is equal to or less than 1.2 times each of the first thickness t1 and the third thickness t3, and the third thickness t3 is equal to or less than 1.2 times each of the first thickness t1 and the second thickness t2. With this configuration, when the electronic component 1 is mounted on a circuit board or the like, the posture of the electronic component 1 can be more stabilized.

Preferably, the first thickness t1 is equal to or less than 1.1 times each of the second thickness t2 and the third thickness t3, the second thickness t2 is equal to or less than 1.1 times each of the first thickness t1 and the third thickness t3, and the third thickness t3 is equal to or less than 1.1 times each of the first thickness t1 and the second thickness t2. With this configuration, when the electronic component 1 is mounted on a circuit board or the like, the posture of the electronic component 1 can be more stabilized.

### (Manufacturing Method)

The electronic component 1 is manufactured by the following method, the method including a step of preparing the base body 10 having the bottom surface 16 (first plane), the first end surface 14 (second plane), and the first ridge portion 11a connecting the bottom surface 16 and the first end surface 14; and a step of forming the first conductive member 301 continuously on at least a part of the bottom surface 16 and at least a part of the first ridge portion 11a such that the bottom surface 16 has the first contact surface S1 that is in contact with the first conductive member 301 and the first ridge portion 11a has the second contact surface S2 that is in contact with the first conductive member 301. The step of forming the first conductive member 301 includes a step of applying a photosensitive conductive paste to at least a part of the bottom surface 16 and at least a part of the first ridge portion 11a. The step of forming the first conductive member 301 also includes a step of exposing the photosensitive conductive paste such that, in a cross section orthogonal to each of the bottom surface 16 and the first end surface 14 and intersecting the first conductive member 301, the first contact surface S1, and the second contact surface S2, when the thickness of the first conductive member 301 at the center portion of the first contact surface S1 is defined as the first thickness t1, and the thickness of the first conductive member 301 at the end portion of the first contact surface S1 on the side opposite to the first ridge portion 11a with respect to the center portion of the first contact surface S1 is defined as the second thickness t2, the first thickness t1 is equal to or less than 1.3 times the second thickness t2, and the second thickness t2 is equal to or less than 1.3 times the first thickness t1. In addition, the step of forming the first conductive member 301 includes a step of developing the photosensitive conductive paste.

### <<Preparation of Base Body>>

A base body 10 is prepared. The base body 10 is obtained, for example, by stacking and firing a plurality of magnetic layers 21 in which the coil wire 22 and the first and second extended conductors 23A and 23B are formed. The firing temperature is not particularly limited, and may be appropriately set in consideration of the types of the material to be used and the like. The configuration of the base body 10 including the coil 20 is as illustrated in FIG. 2.

The magnetic layer 21 is obtained by forming a paste containing a magnetic material into a sheet shape.

Examples of the magnetic material include a Ni—Cu—Zn based ferrite material. The Ni—Cu—Zn based ferrite material contains, for example, Fe in an amount of 40 mol % or more and 49.5 mol % or less (i.e., from 40 mol % to 49.5 mol %) when converted to Fe₂O₃, Zn in an amount of 2 mol % or more and 35 mol % or less (i.e., from 2 mol % to 35 mol %) when converted to ZnO, Cu in an amount of 6 mol % or more and 13 mol % or less (i.e., from 6 mol % to 13 mol %) when converted to CuO, and Ni in an amount of 10 mol % or more and 45 mol % or less (i.e., from 10 mol % to 45 mol %) when converted to NiO. The magnetic material may contain additives and unavoidable impurities as necessary. Additives contain, for example, Mn₃O₄, Co₃O₄, SnO₂, Bi₂O₃, and SiO₂.

Specifically, the magnetic layer 21 is produced, for example, as follows. First, Fe₂O₃, ZnO, CuO, and NiO are weighed out to obtain a predetermined composition. These materials and pure water are placed in a ball mill together with partially stabilized zirconia (PSZ) media, and mixed and ground in a wet manner for 4 to 8 hours. Thereafter, the moisture is evaporated to dryness, and the mixture is calcined at a temperature of 700° C. or higher and 800° C. or lower for 2 to 5 hours. Accordingly, a Ni—Cu—Zn based ferrite material (magnetic material) is obtained.

The obtained magnetic material, an organic binder such as polyvinyl butyral, an organic solvent such as ethanol or toluene, and a plasticizer are placed in a ball mill together with PSZ media and further mixed. Next, the mixture thus obtained is formed into a sheet having a film thickness of 20 μm or more and 30 μm or less (i.e., from 20 μm to 30 μm) by a doctor blade method or the like. Thereafter, the sheet is punched into a predetermined shape (typically a rectangle) to obtain the magnetic layer 21.

In the produced magnetic layer 21, via holes are formed at predetermined locations by, for example, laser irradiation.

Separately, a conductive paste containing a conductive material (typically, Ag powder) as a main component is prepared. The conductive paste may contain a solvent, a resin, a dispersant, and the like in addition to the conductive material. This conductive paste is applied by, for example, a screen printing method, to the magnetic layer 21 in which the via holes are formed. Accordingly, the via holes are filled with the conductive paste, and the coil wire 22 and the first and second extended conductors 23A and 23B are formed.

Subsequently, the plurality of magnetic layers 21 thus produced are stacked in a predetermined order and thermocompression-bonded to produce a multilayer block. Next, the multilayer block is cut into individual pieces using a dicer or the like. The individual pieces are fired in a firing furnace at a temperature of 900° C. or higher and 920° C. or lower (i.e., from 900° C. to 920° C.) for 2 to 4 hours. The fired body is placed in a rotating barrel machine along with media, and the ridges and corners of the fired body are polished by rotating it. Accordingly, the base body 10 having the first to twelfth ridge portions is obtained.

### <<Formation of Outer Electrode>>

Subsequently, a first conductive member 301 and a second conductive member 302 are formed on the entire surfaces of the first end surface 14 and the second end surface 15 of the base body 10, and on a part of each of the first side surface 12, the second side surface 13, the bottom surface 16, and the top surface 17. Accordingly, the first conductive member 301 and the second conductive member 302 are electrically connected to the coil 20.

A method of forming the first conductive member 301 and the second conductive member 302 is, for example, a method of first applying a photosensitive conductive paste containing conductive particles such as Ag powder and a resin composition containing a photosensitive resin to a predetermined location of the base body 10. The application method is not particularly limited, and may be, for example, a dipping method or a screen printing method.

Subsequently, the photosensitive conductive paste is exposed such that the first thickness t1 described above is equal to or less than 1.3 times each of the second thickness t2 and the third thickness t3, the second thickness t2 is equal to or less than 1.3 times each of the first thickness t1 and the third thickness t3, and the third thickness t3 is equal to or less than 1.3 times each of the first thickness t1 and the second thickness t2. In other words, the photosensitive conductive paste is exposed such that the thicknesses of the first conductive member 301 and the second conductive member 302 become uniform.

The exposure method is not particularly limited, and the photosensitive conductive paste can be exposed by, for example, irradiating the photosensitive conductive paste with a laser beam having a wavelength of 355 nm. By using a laser beam capable of drawing with high accuracy, the shapes of the first conductive member 301 and the second conductive member 302 can be controlled with high accuracy. The laser beam is preferably applied such that the temperature of the base body 10 becomes equal to or lower than the firing temperature of the base body 10. Accordingly, the damage to the base body 10 caused by the laser irradiation can be suppressed.

Examples of a method of performing the exposure such that the thicknesses of the first conductive member 301 and the second conductive member 302 become uniform include the following method. In a case where the photosensitive conductive paste is applied to the bottom surface 16 and the first ridge portion 11a by a dipping method or screen-printing, a thickness of the photosensitive conductive paste applied to the first ridge portion 11a and a thickness of the base portion of the photosensitive conductive paste applied to the bottom surface 16 are thinner than a thickness of the other portions. That is, the thickness of the photosensitive conductive paste becomes non-uniform. Therefore, the photosensitive conductive paste may be applied over an area wider than the exposure area, and then the photosensitive conductive paste may be exposed to light except for the above-mentioned base portion where the thickness is relatively thin. The unexposed base portion may then be removed by development, which will be described later. Accordingly, it is possible to make the thickness of the end portion of the photosensitive conductive paste applied onto the bottom surface 16 after development thicker than that in the related art. Furthermore, for the first ridge portion 11a having a relatively thin thickness, the thickness of the first ridge portion 11a may be increased by applying the photosensitive conductive paste a plurality of times only to the first ridge portion 11a. In this manner, the overall thickness of the first conductive member 301 may be made uniform. In addition, the entire thickness of the second conductive member 302 may be made uniform by a similar method.

Subsequently, the base body 10 is immersed in a developer and washed with pure water. The photosensitive conductive paste that has not been irradiated with the laser beam is dissolved by a developer and removed. On the other hand, the exposed photosensitive conductive paste is solidified and remains. The photosensitive conductive paste may be a positive type which is decomposed by a laser beam, or may be a negative type which is polymerized or crosslinked by a laser beam. In a case where a positive type photosensitive resin is used, the portion irradiated with the laser beam is removed by the removal process. In a case where a negative type photosensitive resin is used, a portion not irradiated with the laser beam is removed by the removal process.

Subsequently, the base body 10 is fired at a temperature of, for example, 800° C. or higher and 820° C. or lower (i.e., from 800° C. to 820° C.). The conductive particles are sintered by firing, and the first conductive member 301 and the second conductive member 302 are formed. The firing temperature is not particularly limited, and may be appropriately set in consideration of the types of the material to be used and the like. The relative relationship of the thicknesses when the thicknesses of the respective portions of the first conductive member 301 are compared does not change before and after firing. In other words, in a case where the thickness of the first conductive member 301 after firing is uniform, the thickness of the photosensitive conductive paste before firing, which becomes the first conductive member 301, is also uniform. Similarly, in a case where the thickness of the second conductive member 302 after firing is uniform, the thickness of the photosensitive conductive paste before firing, which becomes the second conductive member 302, is also uniform.

Subsequently, as necessary, a first plating layer 41 and a second plating layer 42, which cover each of the first conductive member 301 and the second conductive member 302, are formed. A method of forming the first plating layer 41 and the second plating layer 42 is not particularly limited, and may be an electroplating method or an electroless plating method. The first plating layer 41 and the second plating layer 42 are formed, for example, by an electroplating method in the order of a Ni plating layer and a Sn plating layer.

As described above, the electronic component 1 is manufactured. An example of the size of the electronic component 1 includes L (length)=0.6 mm, W (width)=0.3 mm, and T (thickness)=0.3 mm.

According to the manufacturing method, it is possible to obtain the electronic component 1 in which entry of gases such as water vapor can be suppressed, for example.

In addition, as described above, in a case where an electrode is formed by applying the conductive paste by a dipping method and then firing the applied paste, the thickness of the center portion of the conductive paste becomes thicker than the thickness of the end portion. Therefore, in order to ensure the overall thickness of the conductive paste by the dipping method, it is necessary to increase the area over which the conductive paste is applied.

Therefore, in order to ensure the minimum thickness by thickening the thin portions, it is necessary to make the thick portions even thicker. In this case, however, the outer dimensions of the electronic component also increase. According to the manufacturing method, since the photosensitive conductive paste applied is patterned using a photolithography method, the overall thickness of the conductive paste can be ensured while reducing the area over which the conductive paste is applied. Therefore, a small electronic component 1 can be obtained.

### Second Embodiment

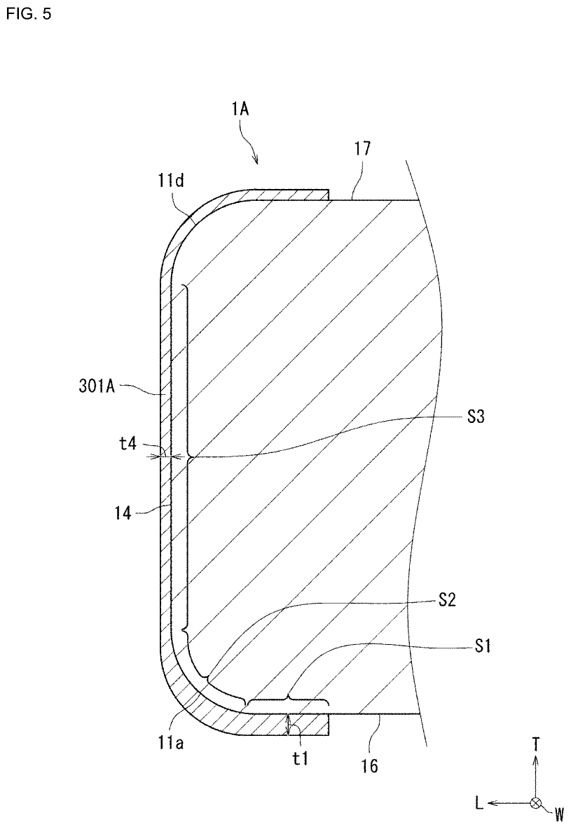

FIG. 5 is a cross-sectional view illustrating a second embodiment of the electronic component. FIG. 5 corresponds to FIG. 2. In FIG. 5, the descriptions of the second end surface side, the coil, and the plating layer are omitted. The second embodiment differs from the first embodiment in the configuration of the conductive member. This different configuration will be described below. The other configurations are the same as those in the first embodiment, and the same reference numerals as those in the first embodiment are used, and the description thereof will be omitted.

In this embodiment, the bottom surface 16 corresponds to the “first plane” recited in the claims. Any ridge portion of the first ridge portion 11a, the second ridge portion 11b, the fifth ridge portion, and the sixth ridge portion connected to the “first plane” corresponds to the “ridge portion” recited in the claims. Any surface of the first end surface 14, the second end surface 15, the first side surface 12, and the second side surface 13 connected to the “ridge portion” corresponds to the “second plane” recited in the claims. Hereinafter, in order to simplify the description, the first end surface 14 and the second end surface 15 will be referred to as the “second plane”, and the first ridge portion 11a and the second ridge portion 11b will be referred to as the “ridge portion”.

A thickness of a portion of a first conductive member 301A provided on the bottom surface 16 side is thicker than thicknesses of the other portions. Specifically, as illustrated in FIG. 5, the first end surface 14 (second plane) has a third contact surface S3 that is in contact with the first conductive member 301A. In a cross section orthogonal to each of the bottom surface 16 (first plane) and the first end surface 14 and intersecting the first conductive member 301A, that is, in FIG. 5, when the thickness of the first conductive member 301A at the center portion of the third contact surface S3 is defined as a fourth thickness t4, the first thickness t1 is thicker than the fourth thickness t4.

A second conductive member 302A (not illustrated) may also have a similar configuration to the first conductive member 301A. That is, the second end surface 15 (second plane) may have a third contact surface that is in contact with the second conductive member 302A. In a cross section orthogonal to each of the bottom surface 16 (first plane) and the second end surface 15 and intersecting the second conductive member 302A, when the thickness of the second conductive member 302A at the center portion of the third contact surface is defined as the fourth thickness, the first thickness may be thicker than the fourth thickness.

In a case where the bottom surface 16 side of the base body 10 is a mounting surface side of an electronic component 1A, when the electronic component 1A is mounted, the molten solder is pushed aside by a part of the first conductive member 301A provided on the bottom surface 16 and wraps around to the first end surface 14 side of the base body 10. The solder that wraps around forms a fillet. According to the present embodiment, since the thickness of a part of the first conductive member 301A provided on the bottom surface 16 is relatively thick, the amount of the solder pushed aside is increased, and the height of the fillet formed on the first end surface 14 side can be increased. As a result, the electronic component 1A can be more firmly fixed to the circuit board or the like.

### Third Embodiment

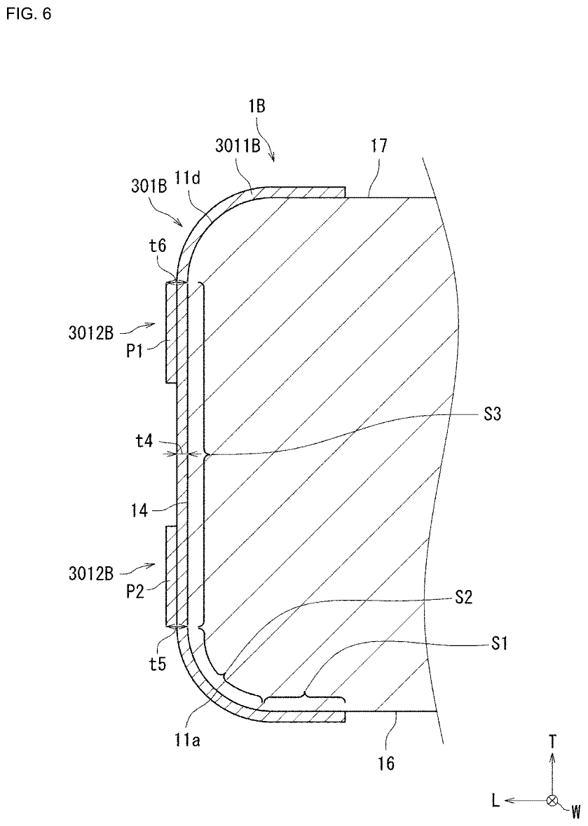

FIG. 6 is a cross-sectional view illustrating a third embodiment of the electronic component. FIG. 6 corresponds to FIG. 2. In FIG. 6, the descriptions of the second end surface side, the coil, and the plating layer are omitted. The third embodiment differs from the first embodiment in the configuration of the conductive member. This different configuration will be described below. The other configurations are the same as those in the first embodiment, and the same reference numerals as those in the first embodiment are used, and the description thereof will be omitted.

In this embodiment, the bottom surface 16 and the top surface 17 correspond to the “first plane” recited in the claims. Any ridge portion of the first to fourth ridge portions 11a to 11d connected to the “first plane” corresponds to the “ridge portion” recited in the claims. Any surface of the first end surface 14 and the second end surface 15 connected to the “ridge portion” corresponds to the “second plane” recited in the claims. Hereinafter, in order to simplify the description, the bottom surface 16 will be referred to as the “first plane”, the first end surface 14 will be referred to as the “second plane”, and the first ridge portion 11a will be referred to as the “ridge portion”.

As illustrated in FIG. 6, the first end surface 14 (second plane) has a third contact surface S3 that is in contact with a first conductive member 301B. In a cross section orthogonal to each of the bottom surface 16 (first plane) and the first end surface 14 and intersecting the first conductive member 301B, that is, in FIG. 6, when the thickness of the first conductive member 301B at the center portion of the third contact surface S3 is defined as a fourth thickness t4, the thickness of the first conductive member 301B at the end portion of the third contact surface S3 located on the first ridge portion 11a side is defined as a fifth thickness t5, and the thickness of the first conductive member 301B at the end portion of the third contact surface S3 located on the side opposite to the first ridge portion 11a with respect to the center portion of the third contact surface S3 is defined as a sixth thickness t6, each of the fifth thickness t5 and the sixth thickness t6 is thicker than the fourth thickness t4.

Specifically, the first conductive member 301B includes a first layer of conductive member 3011B and a second layer of conductive member 3012B stacked on the first layer of conductive member 3011B. The first layer of conductive member 3011B has a similar configuration to the first conductive member 301 described in the first embodiment. The second layer of conductive member 3012B is provided on the first end surface 14. The second layer of conductive member 3012B includes a first portion P1 disposed on the forward T direction side and a second portion P2 disposed on the reverse T direction side when viewed in the L direction.

The first portion P1 has a rectangular shape extending along an end edge of the first end surface 14 on the forward T direction side when viewed in the L direction. The first portion P1 overlaps the end edge of the first end surface 14 on the forward T direction side when viewed in the L direction. The second portion P2 has a rectangular shape extending along an end edge of the first end surface 14 on the reverse T direction side when viewed in the L direction. The second portion P2 overlaps the end edge of the first end surface 14 on the reverse T direction side when viewed in the L direction. The first portion P1 and the second portion P2 are arranged side by side in the T direction and are spaced apart from each other. Since the first conductive member 301B includes the second layer of conductive member 3012B, each of the fifth thickness t5 and the sixth thickness t6 is thicker than the fourth thickness t4. The second conductive member 302B (not illustrated) may also have a similar configuration.

According to the present embodiment, a contact area between the fillet formed during mounting and the first conductive member 301B can be increased compared with a case where the thickness of the portion of the first conductive member 301B provided on the first end surface 14 of the base body 10 is uniform in the plane of the first end surface 14. Therefore, an electronic component 1B can be more firmly fixed to the circuit board or the like.

### Fourth Embodiment

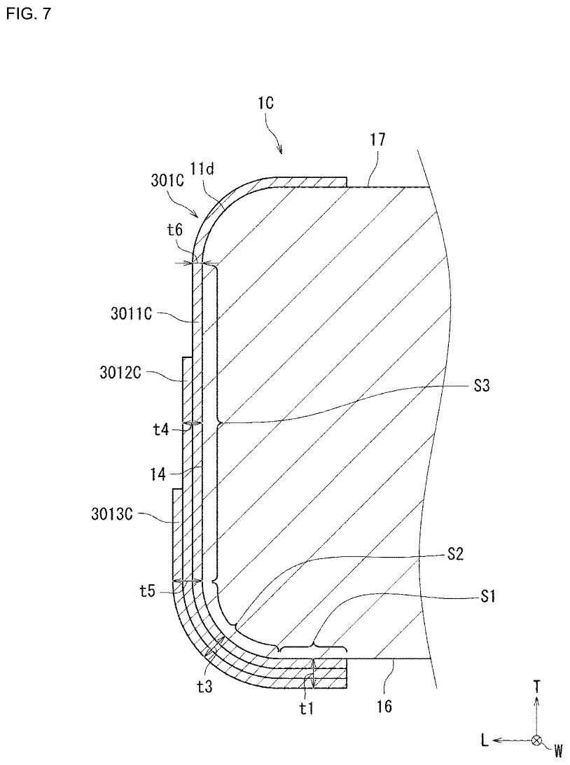

FIG. 7 is a cross-sectional view illustrating a fourth embodiment of the electronic component. FIG. 7 corresponds to FIG. 2. In FIG. 7, the descriptions of the second end surface side, the coil, and the plating layer are omitted. The fourth embodiment differs from the first embodiment in the configuration of the conductive member. This different configuration will be described below. The other configurations are the same as those in the first embodiment, and the same reference numerals as those in the first embodiment are used, and the description thereof will be omitted.

In this embodiment, the bottom surface 16 corresponds to the “first plane” recited in the claims. Any ridge portion of the first ridge portion 11a and the second ridge portion 11b connected to the “first plane” corresponds to the “ridge portion” recited in the claims. Any surface of the first end surface 14 and the second end surface 15 connected to the “ridge portion” corresponds to the “second plane” recited in the claims. Hereinafter, in order to simplify the description, the first end surface 14 will be referred to as the “second plane”, and the first ridge portion 11a will be referred to as the “ridge portion”.

As illustrated in FIG. 7, the first end surface 14 (second plane) has a third contact surface S3 that is in contact with a first conductive member 301C. In a cross section orthogonal to each of the bottom surface 16 (first plane) and the first end surface 14 and intersecting the first conductive member 301C, that is, in FIG. 7, when the thickness of the first conductive member 301C at the end portion of the third contact surface S3 located on the first ridge portion 11a side is defined as a fifth thickness t5, and the thickness of the first conductive member 301C at the end portion of the third contact surface S3 located on the side opposite to the first ridge portion 11a with respect to the center portion of the third contact surface S3 is defined as a sixth thickness t6, the fifth thickness t5 is thicker than the sixth thickness t6.

Specifically, the first conductive member 301C includes a first layer of conductive member 3011C, a second layer of conductive member 3012C stacked on the first layer of conductive member 3011C, and a third layer of conductive member 3013C stacked on the second layer of conductive member 3012C.

The first layer of conductive member 3011C has a similar configuration to the first conductive member 301 described in the first embodiment. The second layer of conductive member 3012C is provided continuously over the end portion of the bottom surface 16 on the forward L direction side, the first ridge portion 11a, and a portion of the first end surface 14 from the end portion on the reverse T direction side to a position slightly on the forward T direction side from the center portion. In the cross section illustrated in FIG. 7, the shape of the second layer of conductive member 3012C is substantially L-shaped. The thickness of the second layer of conductive member 3012C is uniform.

The third layer of conductive member 3013C is provided continuously over the end portion of the bottom surface 16 on the forward L direction side, the first ridge portion 11a, and a portion of the first end surface 14 from the end portion on the reverse T direction side to a position slightly on the reverse T direction side from the center portion. In the cross section illustrated in FIG. 7, the shape of the third layer of conductive member 3013C is substantially L-shaped. The thickness of the third layer of conductive member 3013C is uniform.

With the above-described configuration, the first conductive member 301C at the end portion of the third contact surface S3 located on the first ridge portion 11a side is composed of the first to third layer of conductive members 3011C to 3013C. The first conductive member 301C at the end portion of the third contact surface S3 located on the side opposite to the first ridge portion 11a with respect to the center portion of the third contact surface S3 is composed only of the first layer of conductive member 3011C. Therefore, the fifth thickness t5 is thicker than the sixth thickness t6.

In addition, with the above-described configuration, the first conductive member 301C at the center portion of the third contact surface S3 is composed of the first layer of conductive member 3011C and the second layer of conductive member 3012C. Therefore, the fourth thickness t4, which is the thickness of the first conductive member 301C at the center portion of the third contact surface S3, is thinner than the fifth thickness t5 and thicker than the sixth thickness t6.

In this embodiment, the first conductive member 301C at the center portion of the first contact surface S1 and the first conductive member 301C at the center portion of the second contact surface S2 are each composed of the first to third layer of conductive members 3011C to 3013C. Similarly to the first embodiment, when the thickness of the first conductive member 301C at the center portion of the first contact surface S1 is defined as a first thickness t1 and the thickness of the first conductive member 301C at the center portion of the second contact surface S2 is defined as a third thickness t3, the first thickness t1 is equal to or less than 1.3 times the third thickness t3, and the third thickness t3 is equal to or less than 1.3 times the first thickness t1.

According to the present embodiment, the fifth thickness t5 is thicker than the sixth thickness t6. Accordingly, the area of the first conductive member 301C that can come into contact with the solder is increased compared with a case where the thickness of the portion of the first conductive member 301C provided on the first end surface 14 is uniform. Therefore, an electronic component 1C can be more firmly fixed to the circuit board or the like.

### Fifth Embodiment

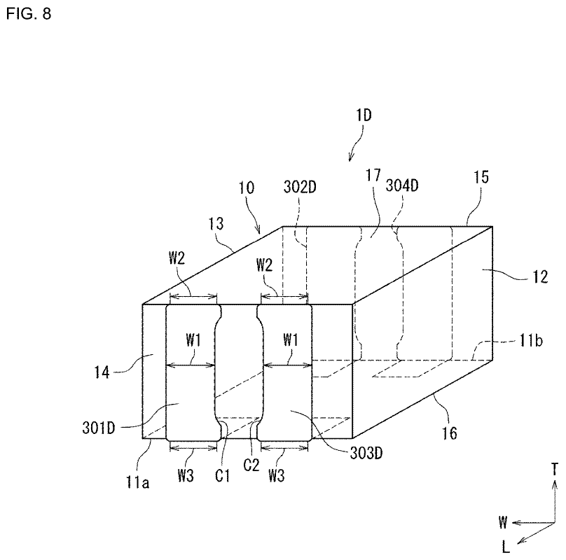

FIG. 8 is a perspective view illustrating a fifth embodiment of the electronic component. In FIG. 8, the descriptions of the coil, and the plating layer are omitted. The fifth embodiment differs from the first embodiment mainly in the configuration of the conductive member. This different configuration will be described below. The other configurations are the same as those in the first embodiment, and the same reference numerals as those in the first embodiment are used, and the description thereof will be omitted.

In this embodiment, the bottom surface 16 corresponds to the “first plane” recited in the claims. Any ridge portion of the first ridge portion 11a and the second ridge portion 11b connected to the “first plane” corresponds to the “ridge portion” recited in the claims. Any surface of the first end surface 14 and the second end surface 15 connected to the “ridge portion” corresponds to the “second plane” recited in the claims. Hereinafter, in order to simplify the description, the first end surface 14 will be referred to as the “second plane”, and the first ridge portion 11a will be referred to as the “ridge portion”.

As illustrated in FIG. 8, the first conductive member 301D and the third conductive member 303D are provided continuously on at least a part of the bottom surface 16 (first plane), at least a part of the first ridge portion 11a, and at least a part of the first end surface 14 (second plane). The first conductive member 301D and the third conductive member 303D are electrically independent of each other.

When viewed in a direction (L direction) orthogonal to the first end surface 14, each of the first conductive member 301D and the third conductive member 303D extends in a direction that is parallel to the first end surface 14 and is from the first ridge portion 11a toward the center of the first end surface 14 (hereinafter, this direction is referred to as a “first direction”). In this embodiment, the first direction is the T direction. When viewed in the direction orthogonal to the first end surface 14 (L direction), the first conductive member 301D and the third conductive member 303D are arranged side by side in a direction orthogonal to the first direction and parallel to the first end surface 14. In this embodiment, the direction orthogonal to the first direction and parallel to the first end surface 14 is the W direction.

Each of the first conductive member 301D and the third conductive member 303D has a width at the center in the extension direction (T direction) smaller than the width of the both end portions in the extension direction. Specifically, a width W1 of the first conductive member 301D at the center in the T direction is smaller than a width W2 of the end portion of the first conductive member 301D on the forward T direction side and a width W3 of the end portion of the first conductive member 301D on the reverse T direction side. In this embodiment, when viewed in the L direction, the end edge of the first conductive member 301D on the reverse W direction side has a first recess C1 that is recessed toward the forward W direction side in a region excluding both end portions of the first conductive member 301D in the T direction.

A width W1 of the third conductive member 303D at the center in the T direction is smaller than a width W2 of the third conductive member 303D at the end portion on the forward T direction side and a width W3 of the third conductive member 303D at the end portion on the reverse T direction side. In this embodiment, when viewed in the L direction, the end edge of the third conductive member 303D on the forward W direction side has a second recess C2 that is recessed toward the reverse W direction side in a region excluding both end portions of the third conductive member 303D in the T direction.

The second conductive member 302D and the fourth conductive member 304D are provided continuously on at least a part of the bottom surface 16 (first plane), at least a part of the second ridge portion 11b, and at least a part of the second end surface 15 (second plane). The second conductive member 302D and the fourth conductive member 304D are electrically independent of each other. Since the shapes of the second conductive member 302D and the fourth conductive member 304D are similar to the shapes of the first conductive member 301D and the third conductive member 303D, respectively, the detailed description thereof will be omitted.

In this embodiment, an electronic component 1D has a plurality of coils. Specifically, a first coil and a second coil (not illustrated) are present inside the base body 10. The first coil and the second coil are electrically independent. The first conductive member 301D is connected to an end portion on one side of the first coil, and the second conductive member 302D is connected to an end portion on the other side of the first coil. The third conductive member 303D is connected to an end portion on one side of the second coil, and the fourth conductive member 304D is connected to an end portion on the other side of the second coil.

According to the present embodiment, even in a case where the first conductive member 301D and the third conductive member 303D, which are electrically independent of each other, are provided at least on the first end surface 14, the width of each of the first conductive member 301D and the third conductive member 303D at the center in the extension direction is smaller than the widths at the both end portions in the extension direction. Therefore, it is possible to suppress the short-circuiting between the first conductive member 301D and the third conductive member 303D adjacent to each other by the solder which spreads out on the base body 10 during mounting of the electronic component 1D.

In addition, even in a case where the second conductive member 302D and the fourth conductive member 304D, which are electrically independent of each other, are provided at least on the second end surface 15, the width of each of the second conductive member 302D and the fourth conductive member 304D at the center in the extension direction is smaller than the widths at the both end portions in the extension direction. Therefore, it is possible to suppress the short-circuiting between the second conductive member 302D and the fourth conductive member 304D adjacent to each other by the solder which spreads out on the base body 10 during mounting of the electronic component 1D.

### Sixth Embodiment

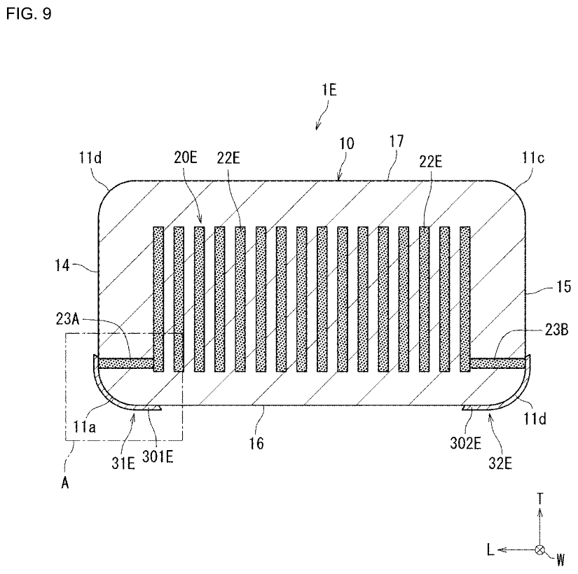

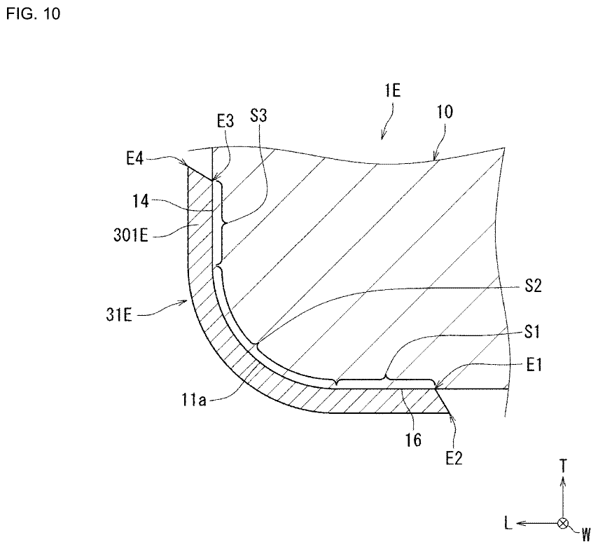

FIG. 9 is a cross-sectional view illustrating a sixth embodiment of the electronic component. FIG. 10 is an enlarged view of part A in FIG. 9. FIG. 9 corresponds to FIG. 2. In FIG. 9, the description of the plating layer is omitted. In FIG. 10, the descriptions of the coil, and the plating layer are omitted. The sixth embodiment differs from the first embodiment mainly in the configurations of the conductive member and the coil. This different configuration will be described below. The other configurations are the same as those in the first embodiment, and the same reference numerals as those in the first embodiment are used, and the description thereof will be omitted.

In this embodiment, the bottom surface 16 corresponds to the “first plane” recited in the claims. Any ridge portion of the first ridge portion 11a and the second ridge portion 11b connected to the “first plane” corresponds to the “ridge portion” recited in the claims. Any surface of the first end surface 14 and the second end surface 15 connected to the “ridge portion” corresponds to the “second plane” recited in the claims. Hereinafter, in order to simplify the description, the first end surface 14 and the second end surface 15 will be referred to as the “second plane”, and the first ridge portion 11a and the second ridge portion 11b will be referred to as the “ridge portion”.

As illustrated in FIG. 9, an electronic component 1E is a horizontally wound coil component in which the axial direction of a coil 20E is parallel to the L direction. The coil 20E includes a plurality of coil wires 22E arranged side by side in the L direction, a first extended conductor 23A connected to the coil wire 22E disposed furthest on the forward L direction side, and a second extended conductor 23B connected to the coil wire 22E disposed furthest on the reverse L direction side. Each coil wire 22E is wound along a plane parallel to the TW plane. It is preferable that each coil wire 22E is wound with less than one turn. The adjacent coil wires 22E are electrically connected to each other with a via conductor (not illustrated) interposed therebetween.

The first conductive member 301E is provided continuously only with at least a part of the bottom surface 16 (first plane), at least a part of the first ridge portion 11a, and at least a part of the first end surface 14 (second plane). Specifically, the first conductive member 301E is provided continuously only with the end portion of the first end surface 14 on the reverse T direction side, the entire surface of the first ridge portion 11a, and the end portion of the bottom surface 16 on the forward L direction side. Accordingly, the area of the region on the outer surface of the base body 10 where the first conductive member 301E is provided can be reduced, thereby suppressing the parasitic capacitance that can be generated between the coil 20E and the first conductive member 301E. As a result, the high frequency characteristics of the electronic component 1E can be improved. The first conductive member 301E is connected to the first extended conductor 23A and is electrically connected to the coil 20E.

The second conductive member 302E is provided continuously only with at least a part of the bottom surface 16 (first plane), at least a part of the second ridge portion 11b, and at least a part of the second end surface 15 (second plane). Specifically, the second conductive member 302E is provided continuously only with the end portion of the second end surface 15 on the reverse T direction side, the entire surface of the second ridge portion 11b, and the end portion of the bottom surface 16 on the reverse L direction side. Accordingly, the area of the region on the outer surface of the base body 10 where the second conductive member 302E is provided can be reduced, thereby suppressing the parasitic capacitance that can be generated between the coil 20E and the second conductive member 302E. As a result, the high frequency characteristics of the electronic component 1E can be improved. The second conductive member 302E is connected to the second extended conductor 23B and is electrically connected to the coil 20E.

As illustrated in FIG. 10, an end portion E1 of the first contact surface S1 on the side opposite to the first ridge portion 11a with respect to the center portion of the first contact surface S1 is located closer to the center portion side of the first contact surface S1 than an outermost end E2 of the first conductive member 301E on the side opposite to the first ridge portion 11a with respect to the center portion of the first contact surface S1. Specifically, the shape of the end portion of the first conductive member 301E on the bottom surface 16 side is a reverse tapered shape. Accordingly, when the electronic component 1E is mounted, it is possible to suppress the excessive spreading-out of the molten solder in a region of the bottom surface 16 of the base body 10 where the first conductive member 301E is not provided. In addition, the solder enters the gap between the above-described end portion having a reverse tapered shape and the bottom surface 16, so that an anchor effect occurs, and the electronic component 1E can be more securely fixed to the circuit board or the like.

In addition, an end portion E3 of the third contact surface S3 on the side opposite to the first ridge portion 11a with respect to the center portion of the third contact surface S3 is located closer to the center portion side of the third contact surface S3 than an outermost end E4 of the first conductive member 301E on the side opposite to the first ridge portion 11a with respect to the center portion of the third contact surface S3. Specifically, the shape of the end portion of the first conductive member 301E on the forward L direction side in the portion provided on the first end surface 14 is a reverse tapered shape. Accordingly, when the electronic component 1E is mounted, it is possible to suppress the excessive spreading-out of the molten solder in a region of the first end surface 14 of the base body 10 where the first conductive member 301E is not provided. In addition, the solder enters the gap between the above-described end portion having a reverse tapered shape and the first end surface 14, so that an anchor effect occurs, and the electronic component 1E can be more securely fixed to the circuit board or the like.

The same applies to the shape of the end portion of the second conductive member 302E. That is, an end portion of the first contact surface on the side opposite to the fourth ridge portion 11d with respect to the center portion of the first contact surface that is in contact with the second conductive member 302E on the bottom surface 16 is located closer to the center portion side of the first contact surface than the outermost end of the second conductive member 302E on the side opposite to the fourth ridge portion 11d with respect to the center portion of the first contact surface. Specifically, the shape of the end portion of the second conductive member 302E on the bottom surface 16 side is a reverse tapered shape. In addition, an end portion of the third contact surface on the side opposite to the fourth ridge portion 11d with respect to the center portion of the third contact surface that is in contact with the second conductive member 302E on the second end surface 15 is located closer to the center portion side of the third contact surface than the outermost end of the second conductive member 302E on the side opposite to the fourth ridge portion 11d with respect to the center portion of the third contact surface. Specifically, the shape of the end portion of the second conductive member 302E on the forward T direction side in the portion provided on the second end surface 15 is a reverse tapered shape.

The present disclosure is not limited to the above-described embodiments, and design modifications are possible without departing from the gist of the present disclosure. For example, the respective characteristic points of the first to sixth embodiments may be combined in various ways.

In the above embodiments, the electronic component is a coil component, but the electronic component is not limited to a coil component. For example, the electronic component may be a capacitor or a resistor. Even in this case, according to the present disclosure, the thickness of the end portion of the conductive member can be made thicker than in the related art, and therefore, for example, the entry of gases such as water vapor from the end portion can be suppressed.

In the above embodiments, the coil has a form in which the coil wires wound with less than one turn are stacked, but the form of the coil is not particularly limited. For example, the coil may have a form in which coil wires having a straight shape, a meander shape, or the like are stacked.

In the above embodiments, the conductive member is provided on both the first end surface side and the second end surface side of the base body, but the conductive member may be provided only on any one of the first end surface side or the second end surface side.

In the third and fourth embodiments, the conductive member has a stacked configuration, but the conductive member may have an integrated configuration.

In the fifth embodiment, two conductive members that are electrically independent of each other, that is, the first conductive member and the third conductive member, are provided on the first end surface side of the base body, but three or more conductive members may be provided thereon. The same applies to the conductive member on the second end surface side.

In the sixth embodiment, both the end portion on the first end surface side and the end portion on the bottom surface side of the first conductive member had the reverse tapered shape, but any one of them may have the reverse tapered shape.

What is claimed is:

1. An electronic component comprising:
a base body having a first plane, a second plane, and a ridge portion connecting the first plane and the second plane; and
a conductive member continuously on at least a part of the first plane and at least a part of the ridge portion, wherein
the first plane has a first contact surface that is in contact with the conductive member,
the ridge portion has a second contact surface that is in contact with the conductive member, and
in a cross section orthogonal to each of the first plane and the second plane and intersecting the conductive member, the first contact surface, and the second contact surface, when a thickness of the conductive member in a direction orthogonal to the first plane at a center portion of the first contact surface in the cross section is defined as a first thickness, and a thickness of the conductive member in the direction orthogonal to the first plane at an end portion of the first contact surface on a side opposite to the ridge portion with respect to the center portion of the first contact surface in the cross section is defined as a second thickness, the first thickness is equal to or less than 1.3 times the second thickness, and the second thickness is equal to or less than 1.3 times the first thickness.

2. The electronic component according to claim 1, wherein
the first plane is a mounting surface, and
in the cross section, when a thickness of the conductive member in a direction that passes through a center portion of the second contact surface in the cross section and is orthogonal to a plane in contact with the center portion of the second contact surface is defined as a third thickness, the first thickness is equal to or less than 1.3 times the third thickness, the second thickness is equal to or less than 1.3 times the third thickness, and the third thickness is equal to or less than 1.3 times each of the first thickness and the second thickness.

3. The electronic component according to claim 2, wherein
the first thickness is equal to or less than 1.2 times each of the second thickness and the third thickness, the second thickness is equal to or less than 1.2 times each of the first thickness and the third thickness, and the third thickness is equal to or less than 1.2 times each of the first thickness and the second thickness.

4. The electronic component according to claim 1, wherein
in the cross section, the end portion of the first contact surface is closer to the center portion side of the first contact surface than an outermost end of the conductive member on the side opposite to the ridge portion with respect to the center portion of the first contact surface.

5. The electronic component according to claim 1, wherein
the conductive member extends continuously on at least a part of the first plane, at least a part of the ridge portion, and at least a part of the second plane,
the second plane has a third contact surface that is in contact with the conductive member, and
in the cross section, an end portion of the third contact surface on a side opposite to the ridge portion with respect to a center portion of the third contact surface is located closer to a center portion side of the third contact surface than an outermost end of the conductive member on the side opposite to the ridge portion with respect to the center portion of the third contact surface.

6. The electronic component according to claim 1, wherein
the conductive member extends continuously on at least a part of the first plane, at least a part of the ridge portion, and at least a part of the second plane,
the second plane has a third contact surface that is in contact with the conductive member, and
in the cross section, when a thickness of the conductive member in a direction orthogonal to the second plane at a center portion of the third contact surface is defined as a fourth thickness, the first thickness is thicker than the fourth thickness.

7. The electronic component according to claim 1, wherein
the conductive member extends continuously on at least a part of the first plane, at least a part of the ridge portion, and at least a part of the second plane,
the second plane has a third contact surface that is in contact with the conductive member, and
in the cross section, when a thickness of the conductive member in a direction orthogonal to the second plane at a center portion of the third contact surface is defined as a fourth thickness, a thickness of the conductive member in the direction orthogonal to the second plane at an end portion of the third contact surface located on the ridge portion side is defined as a fifth thickness, and a thickness of the conductive member in the direction orthogonal to the second plane at an end portion of the third contact surface located on a side opposite to the ridge portion with respect to the center portion of the third contact surface is defined as a sixth thickness, each of the fifth thickness and the sixth thickness is thicker than the fourth thickness.

8. The electronic component according to claim 1, wherein
the conductive member extends continuously on at least a part of the first plane, at least a part of the ridge portion, and at least a part of the second plane,
the second plane has a third contact surface that is in contact with the conductive member, and
in the cross section, when a thickness of the conductive member in a direction orthogonal to the second plane at an end portion of the third contact surface located on the ridge portion side is defined as a fifth thickness, and a thickness of the conductive member in the direction orthogonal to the second plane at an end portion of the third contact surface located on a side opposite to the ridge portion with respect to a center portion of the third contact surface is defined as a sixth thickness, the fifth thickness is thicker than the sixth thickness.

9. The electronic component according to claim 1, wherein
the conductive member extends continuously on at least a part of the first plane, at least a part of the ridge portion, and at least a part of the second plane,
the conductive member includes a plurality of conductive members, and the plurality of conductive members are on at least a part of the second plane and electrically independent of each other,
when viewed in a direction orthogonal to the second plane, the plurality of conductive members extend in a first direction that is parallel to the second plane and is from the ridge portion toward a center of the second plane, and are arranged side by side in a direction that is orthogonal to the first direction and is parallel to the second plane, and
in each of the plurality of conductive members, a width of a center in an extension direction is smaller than each of widths of both end portions of the extension direction.

10. The electronic component according to claim 1, further comprising:
a coil that is in the base body and is electrically connected to the conductive member.

11. The electronic component according to claim 10, wherein
the conductive member is continuous only with at least a part of the first plane, at least a part of the ridge portion, and at least a part of the second plane.

12. The electronic component according to claim 2, wherein
in the cross section, the end portion of the first contact surface is closer to the center portion side of the first contact surface than an outermost end of the conductive member on the side opposite to the ridge portion with respect to the center portion of the first contact surface.

13. The electronic component according to claim 2, wherein
the conductive member extends continuously on at least a part of the first plane, at least a part of the ridge portion, and at least a part of the second plane,
the second plane has a third contact surface that is in contact with the conductive member, and
in the cross section, an end portion of the third contact surface on a side opposite to the ridge portion with respect to a center portion of the third contact surface is located closer to a center portion side of the third contact surface than an outermost end of the conductive member on the side opposite to the ridge portion with respect to the center portion of the third contact surface.

14. The electronic component according to claim 2, wherein
the conductive member extends continuously on at least a part of the first plane, at least a part of the ridge portion, and at least a part of the second plane,
the second plane has a third contact surface that is in contact with the conductive member, and
in the cross section, when a thickness of the conductive member in a direction orthogonal to the second plane at a center portion of the third contact surface is defined as a fourth thickness, the first thickness is thicker than the fourth thickness.

15. The electronic component according to claim 2, wherein
the conductive member extends continuously on at least a part of the first plane, at least a part of the ridge portion, and at least a part of the second plane,
the second plane has a third contact surface that is in contact with the conductive member, and
in the cross section, when a thickness of the conductive member in a direction orthogonal to the second plane at a center portion of the third contact surface is defined as a fourth thickness, a thickness of the conductive member in the direction orthogonal to the second plane at an end portion of the third contact surface located on the ridge portion side is defined as a fifth thickness, and a thickness of the conductive member in the direction orthogonal to the second plane at an end portion of the third contact surface located on a side opposite to the ridge portion with respect to the center portion of the third contact surface is defined as a sixth thickness, each of the fifth thickness and the sixth thickness is thicker than the fourth thickness.

16. A manufacturing method of an electronic component, the manufacturing method comprising:
preparing a base body having a first plane, a second plane, and a ridge portion connecting the first plane and the second plane; and
forming a conductive member, the conductive member being formed continuously on at least a part of the first plane and at least a part of the ridge portion such that the first plane has a first contact surface that is in contact with the conductive member and the ridge portion has a second contact surface that is in contact with the conductive member, wherein
the forming of the conductive member includes
applying a photosensitive conductive paste to at least a part of the first plane and at least a part of the ridge portion,
exposing the photosensitive conductive paste such that, in a cross section orthogonal to each of the first plane and the second plane and intersecting the conductive member, the first contact surface, and the second contact surface, when a thickness of the conductive member in a direction orthogonal to the first plane at a center portion of the first contact surface in the cross section is defined as a first thickness, and a thickness of the conductive member in the direction orthogonal to the first plane at an end portion of the first contact surface on a side opposite to the ridge portion with respect to the center portion of the first contact surface in the cross section is defined as a second thickness, the first thickness is equal to or less than 1.3 times the second thickness, and the second thickness is equal to or less than 1.3 times the first thickness, and
developing the photosensitive conductive paste.

17. The manufacturing method of an electronic component according to claim 16,
wherein in the exposing, the photosensitive conductive paste is further exposed such that, when a thickness of the conductive member in a direction that passes through a center portion of the second contact surface in the cross section and is orthogonal to a plane in contact with the center portion of the second contact surface is defined as a third thickness, the first thickness is equal to or less than 1.3 times the third thickness, the second thickness is equal to or less than 1.3 times the third thickness, and the third thickness is equal to or less than 1.3 times each of the first thickness and the second thickness.

18. The manufacturing method of an electronic component according to claim 16, wherein
in the exposing, the photosensitive conductive paste is exposed by irradiating the photosensitive conductive paste with a laser beam.

19. The manufacturing method of an electronic component according to claim 17, wherein
in the exposing, the photosensitive conductive paste is exposed by irradiating the photosensitive conductive paste with a laser beam.

20. The manufacturing method of an electronic component according to claim 19, wherein
the laser beam is applied such that a temperature of the base body becomes equal to or lower than a firing temperature of the base body.
